(19) United States
(12) Patent Application Publication
(10) Pub. No.: US 2026/0159532 A1
(43) Pub. Date: Jun. 11, 2026

(54) ZINC BORYL COMPLEX AND ITS PREPARATION

(71) Applicant: City University of Hong Kong, Kowloon (HK)

(72) Inventors: Zhenpin Lu, Kowloon (HK); Gan Xu, Kowloon (HK)

(21) Appl. No.: 19/355,211

(22) Filed: Oct. 10, 2025

Related U.S. Application Data
(60) Provisional application No. 63/728,912, filed on Dec. 6, 2024.

(51) Int. Cl. C07F 5/02; B01J 31/14

(52) U.S. Cl. CPC C07F 5/025; B01J 31/146; B01J 2531/0213; C07B 2200/13

(57) ABSTRACT

A zinc boryl complex including a formula of Formula (I), wherein R₁ is an alkyl having 1 to 6 carbon atoms; and R₂ is an aryl having 6 to 18 carbon atoms. The method for preparing the zinc boryl complex is also addressed.

### TECHNICAL FIELD

The present invention relates to a zinc boryl complex, for example, particularly, but not exclusively, a zinc boryl complex comprising a β-diketiminate ligand and a boron-ester based ligand. The present invention also relates to the preparation of the zinc boryl complex.

### BACKGROUND OF THE INVENTION

It is believed that organozinc compounds may be widely applicable in various synthetic chemistry. One of the typical examples may be zinc-carbon bonded reagents, such as ZnEt₂, which serve as mild carbon-centered nucleophiles in organic synthesis. Heteroatom-zinc species, on the other hand, has been attracted a growing interest in organic synthesis, due to the brief that the heteroatom may introduce certain reactivity to the Zn-heteroatom bond. One of the examples may be the zinc-boryl species.

It is believed that synthesis of the zinc-boryl species generally relies on nitrogen-stabilized bulky boryl frameworks, with lithium boryl compounds being the precursors (FIG. 1). These zinc-boryl reagents, however, have been demonstrated to show limited reactivity.

The present invention thus seeks to eliminate or at least mitigate such shortcomings by providing a new or otherwise improved zinc boryl complex.

### SUMMARY OF THE INVENTION

In a first aspect of the present invention, there is provided a zinc boryl complex comprising a formula of:

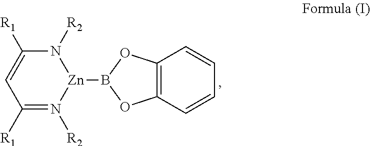

wherein R₁ is an alkyl having 1 to 6 carbon atoms; and R₂ is an aryl having 6 to 18 carbon atoms.

Optionally, R₁ is selected from the group consisting of methyl, ethyl, isopropyl and tert-butyl.

It is optional that R₂ is selected form the group consisting of mesityl (Mes), 2,6-diisopropylphenyl (Dipp), xylyl (Xyl), 2,6-diethylphenyl (Dep) and 2,4,6-triisopropylphenyl (Trip).

In an optional embodiment, the zinc boryl complex comprises a formula of:

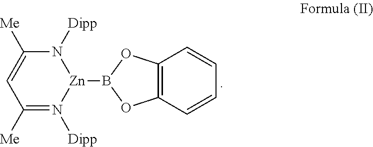

Optionally, the zinc boryl complex as claimed in claim 4 adopts a monomeric state in solution.

It is optional that the zinc boryl complex adopts as a dimer in solid state.

Optionally, the zinc boryl complex is arranged to form an alkyl-substituted boronic ester by way of a nucleophilic reaction with a haloalkane under room temperature.

It is optional that the zinc boryl complex is arranged to form a zincate-borylation intermediate by way of addition reaction of a C═N bond from carbodiimide.

Optionally, the zincate-borylation intermediate is arranged to form an imide zinc complex by way of C═N bond cleavage.

It is optional that the zinc boryl complex is arranged to form an isonitrile-coupled adduct, said adduct including a four-membraned C₂NB heterocycle.

Optionally, the zinc boryl complex is arranged to form a zinc imide complex including a borylated N—N bond by way of reaction with azobenzene.

Optionally, the zinc boryl complex is arranged to act as a catalyst in diborylation reaction with azobenzene.

In a second aspect of the present invention, there is provided a method for preparing zinc boryl complex in accordance with the first aspect, comprising the step of contacting a zinc imide complex with bis(catecholato)diboron for metathesis reaction; wherein the zinc imide complex comprising a formula of:

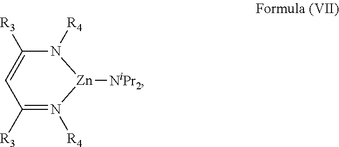

wherein R₃ is an alkyl having 1 to 6 carbon atoms; and R₄ is an aryl having 6 to 18 carbon atoms.

Optionally, R₃ is selected from the group consisting of methyl, ethyl, isopropyl and tert-butyl.

It is optional that R₄ is selected form the group consisting of mesityl (Mes), 2,6-diisopropylphenyl (Dipp), xylyl (Xyl), 2,6-diethylphenyl (Dep) and 2,4,6-triisopropylphenyl (Trip).

In an optional embodiment, the zinc imide complex comprises a formula of:

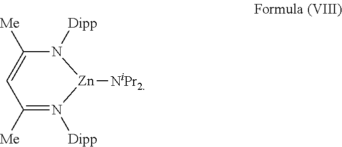

Optionally, the contacting comprises contacting the zinc imide complex and the bis(catecholato)diboron in a solvent.

It is optional that the method comprises the steps of: dissolving the bis(catecholato)diboron in a toluene solution of the zinc imide complex to form a reaction mixture for metathesis reaction; and isolating the zinc boryl complex from the reaction mixture after the metathesis reaction.

Optionally, the zinc imide complex and the bis(catecholato)diboron have a molar ratio of about 1:1.

It is optional that the zinc boryl complex is isolated as single crystals.

### BRIEF DESCRIPTION OF DRAWINGS

The invention will now be more particularly described, by way of example only, with reference to the accompanying drawings, in which:

FIG. 1 is a schematic diagram illustrating examples of zinc boryl compounds derived from boryllithium;

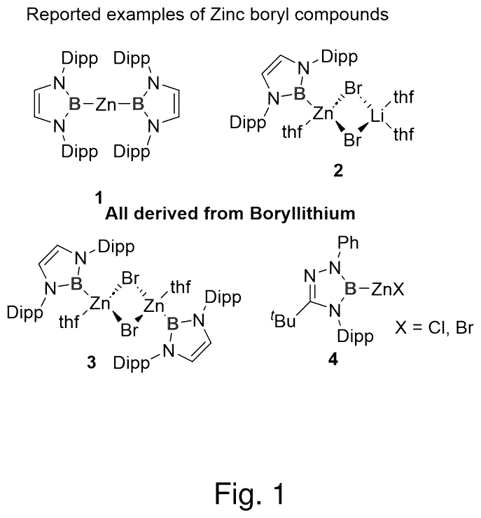

FIG. 2A is a table summarizing the crystallographic data of compounds 6, 12, and 13 in accordance with the embodiments of the present invention;

FIG. 2B is a table summarizing the crystallographic data of compounds 8, 10, and 11 in accordance with the embodiments of the present invention;

FIG. 3 shows the in-situ ¹H NMR spectrum of the reaction B₂Cat₂ with compound 13;

FIG. 4 is a synthetic scheme of zinc boryl compound 6;

FIG. 5 shows the molecular structure of the dimer of compound 6. (thermal ellipsoids are set at the 50% probability level, and the hydrogen atoms are omitted for clarity);

FIG. 6 shows the characteristic molecular orbitals of compound 6 calculated at the BP86 level of theory;

FIG. 7 is a synthetic scheme illustrating the reaction of compound 6 with DMAP;

FIG. 8 is a synthetic scheme illustrating the reaction of compound 6 with Mel;

FIG. 9 is a synthetic scheme illustrating the reaction of compound 6 with N,N′-dicyclohexylcarbodiimide;

FIG. 10A shows the molecular structure of compound 11 (left) and 10 (right). (thermal ellipsoids are set at the 50% probability level, and the hydrogen atoms are omitted for clarity);

FIG. 10B shows the ¹¹B NMR spectrum of 11 in C₆D₆ (linewidth 636.2 Hz);

FIG. 10C shows the ¹H NMR spectrum of 11 in C₆D₆;

FIG. 11 is a synthetic scheme illustrating the reaction of compound 6 with isocyanide;

FIG. 12 shows the molecular structure of compound 12. (thermal ellipsoids are set at the 50% probability level, and the hydrogen atoms are omitted for clarity);

FIG. 13 is synthetic scheme illustrating the reaction of compound 6 with azobenzene;

FIG. 14 shows the molecular structure of compound 13. (thermal ellipsoids are set at the 50% probability level, and the hydrogen atoms are omitted for clarity);

FIG. 15 is synthetic scheme illustrating the catalytic diborylation of azobenzene enabled by compound 6;

FIG. 16 shows the calculated free energy profile for the reaction of compound 6′ with DCC. Relative Gibbs free energies and relative electronic energies (in parenthesis) are given in kcal/mol; and

FIG. 17 shows the energy Profile considering nucleophilic attack of BCat of 6′ on DCC.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

The inventors have, through their own researches, trials and experiments devised that zinc-boryl complex may be prepared from diboron esters such as B₂Pin₂, B₂Cat₂ and the like. In particular, it is devised that stable metal-boryl bonds such as Zn—B bonds may be achieved by introducing bulky ligands such as β-diketiminate species at the metal sites, thereby enhancing the reactivity of the Zn—B bond. Without wishing to the be bound by theory, the inventors have devised a zinc-boryl complex derived from a zinc imide complex/compound and a diboron ester via metathesis reaction. In some exemplary embodiments, the zinc-boryl complex as described herein may act as a nucleophile, engaging productively with an electrophilic partner; exhibit a rich diverse reactivity profile, undergoing transformations with N-containing unsaturated substrates such as carbodiimide, azobenzenes, and isonitriles and the like; and may be a competent catalyst in diboration processes.

In a first aspect of the present invention, there is provided a zinc boryl complex comprising a formula of:

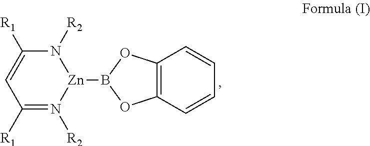

wherein R₁ is an alkyl having 1 to 6 carbon atoms; and R₂ is an aryl having 6 to 18 carbon atoms.

The alkyl may be linear or branched, and may be with 1-6 carbon atoms. Examples of C1-C6 linear alkyl may include methyl, ethyl, propyl, butyl, pentyl and hexyl. Examples of corresponding branched alkyl may include isopropyl, n-butyl, isobutyl, sec-butyl, tert-butyl, n-pentyl (amyl), tert-pentyl, neopentyl, isopentyl (isoamyl), sec-pentyl, 3-pentyl, sec-isopentyl, active pentyl and the like.

The aryl as described herein may have a total carbon of 6 to 18. Examples of the aryl group may include phenyl, tolyl, tert-butylphenyl, xylyl, naphthyl, indenyl, azulenyl, cumyl, mesityl (Mes), 2,6-diisopropylphenyl (Dipp), 2,6-diethylphenyl (Dep), 2,4,6-triisopropylphenyl (Trip) and the like.

In some embodiments, R₁ may be selected from the group consisting of methyl, ethyl, isopropyl and tert-butyl. In some embodiments, R₂ may be selected form the group consisting of mesityl (Mes), 2,6-diisopropylphenyl (Dipp), xylyl (Xyl), 2,6-diethylphenyl (Dep) and 2,4,6-triisopropylphenyl (Trip). In some example embodiments, the zinc boryl complex may be selected from the group consisting of:

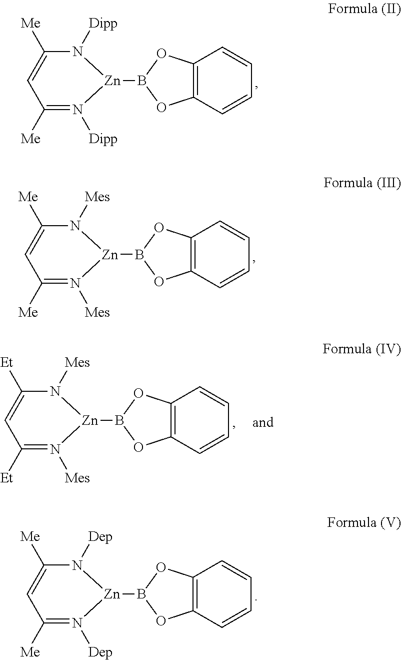

In an exemplary embodiment, the zinc boryl complex may have a formula of:

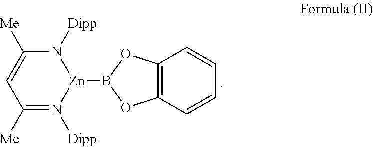

In this exemplary embodiment, the zinc boryl complex may adopt a monomeric state in solution while in solid state the zinc boryl complex may adopt a dimeric structure (a dimer). In particular, when the zinc boryl complex is in dimer form, it is devised that the zinc atom may be connected with an oxygen atom from the BCat group through a weak coordination interaction, forming a six-membered ring structure that is illustrated in Formula (VI):

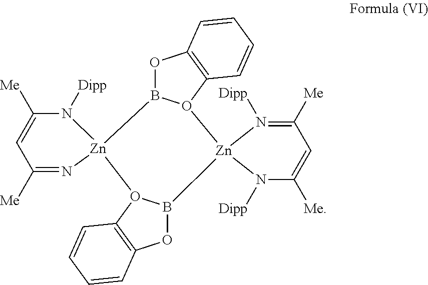

Metal boryl complexes may serve as essential reactive intermediates or catalysts in the formation of various borylated reagents used in organic synthesis, and the reactivity of the metal-boron bond may be crucial for further transformation. Without wishing to be bound by theory, it is believed that the zinc boryl complex as described herein may have an enhanced Zn—B bond reactivity, and therefore said zinc boryl complex may be applied in various organic synthesis or catalysis.

For example, in an embodiment, the zinc boryl complex such as the zinc boryl complex of Formula (II) may be arranged to form an alkyl-substituted boronic ester by way of a nucleophilic reaction with a haloalkane (such as Mel) under room temperature. It is believed that the formation of the alkyl-substituted boronic ester may be a result of the nucleophilic BCat⁻ anion derived from the Zn—B σ-bond of the zinc boryl complex. In another embodiment, the zinc boryl complex may be arranged to form a zincate-borylation intermediate by way of addition reaction of a C═N bond from carbodiimide. The zinc atom (of the zinc boryl complex) may coordinate with the central carbon atom of the carbodiimide whereas the BCat group (of the zinc boryl complex) may be connected to the terminal N—R (R is a substituent) moiety, forming a 1,2-addition compound. Without wishing to be bound by theory, the zincate-borylation intermediate may be a stable transition intermediate that may be arranged to form an imide zinc complex by way of C═N bond cleavage. In yet another embodiment, the zinc boryl complex may be arranged to form an isonitrile-coupled adduct and said adduct may include a four-membraned C₂NB heterocycle. In particular, it is believed that four-membraned C₂NB heterocycle may be a result of the formation of a C—C coupled moiety derived from the isonitrile, coordinated with the BCat unit of the zinc boryl complex. In yet further another embodiment, the zinc boryl complex may be arranged to form a zinc imide complex including a borylated N—N bond by way of reaction with azobenzene. Without wishing to be bound by theory, it is unexpected found the zinc boryl complex may be regenerated when reacting with an additional B₂Cat₂ unit, forming a catalytic cycle. In other words, the zinc boryl complex in this embodiment may act as a catalyst in borylation-related reaction involving azobenzene, such as diborylation of azobenzene.

The method for preparing the zinc boryl complex as described herein will now be disclosed. The method may comprise the step of contacting a zinc imide complex with bis(catecholato)diboron (B₂Cat₂) for metathesis reaction; wherein the zinc imide complex comprising a formula of:

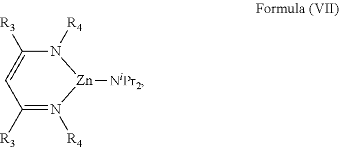

wherein R₃ is an alkyl having 1 to 6 carbon atoms; and R₄ is an aryl having 6 to 18 carbon atoms. The alkyl of R₃ and the aryl of R₄ may be identical to those as described herein. In some particular embodiments, R₃ may be selected from the group consisting of methyl, ethyl, isopropyl and tert-butyl. In some particular embodiments, R₄ may be selected form the group consisting of mesityl (Mes), 2,6-diisopropylphenyl (Dipp), xylyl (Xyl), 2,6-diethylphenyl (Dep) and 2,4,6-triisopropylphenyl (Trip).

In an exemplary embodiment, the zinc imide complex may comprise a formula of:

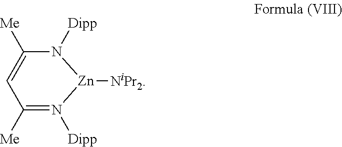

The contacting step may comprise contacting the zinc imide complex and the bis(catecholato)diboron in a solvent. In Particular, the bis(catecholato)diboron may be dissolved in toluene solution of the zinc imide complex to form a reaction mixture for said metathesis reaction. In some embodiments, the zinc imide complex and the bis(catecholato)diboron may have a molar ratio of about 1:1 (e.g., 0.9:1, 0.96:1, 1:1.06, 1:1, 0.99:0.98, 1:0.97 and the like). The reaction mixture may be stirred at about 500 rpm to about 800 rpm under room temperature for at least 8 hours, such as 8 hours to 24 hours for metathesis reaction. After that, the zinc boryl complex from the reaction mixture may be isolated from the reaction mixture. In some example embodiments, said isolation may comprise the steps of: removing the solvent (such as toluene) from the reaction mixture under a reduced pressure to obtain a residue; extracting the (raw/crude) zinc boryl complex from the residue with a suitable solvent (such as hexane) for at least one time (e.g., 3 times) (e.g., by way of suction filtration); and purifying the (raw/crude) zinc boryl complex by way of recrystallization in a frozen concentrated hexane solution, thereby obtaining the zinc boryl complex as single crystals. In some embodiments, the method as described herein may result in about 53% yield of desired zinc boryl complex.

Hereinafter, the present invention is described more specifically by way of examples, but the present invention is not limited thereto.

### EXAMPLES

### Materials and Methods

### Materials

All manipulations were conducted under a dry argon atmosphere using either a Vigor glove box or a standard Schlenk line. Ether, hexane, pentane, and toluene were refluxed over sodium metal and benzophenone until dry, followed by distillation under a nitrogen atmosphere. Tetrahydrofuran (THF) was similarly refluxed over potassium metal and benzophenone until dry and subsequently distilled under a nitrogen atmosphere. All the solvents were degassed prior to use and stored over activated 3 Å molecular sieves in the glove box. NacNac(Dipp)ZnNⁱPr₂ was synthesized by reported method, while all the other chemicals were purchased from commercial companies. Deuterated benzene (C₆D₆) was degassed via three freeze-pump-thaw cycles and then dried over a Na/K alloy in the glove box. NMR spectroscopy was performed on Bruker Avance spectrometers at 300, 400, and 600 MHz. Chemical shifts (δ) are given in ppm relative to the residual proton (¹H) signal or carbon nuclei (¹³C{¹H}) of the respective solvent's residual. The ¹¹B NMR spectra were referenced to external BF₃·OEt₂ standards. High-resolution mass spectra were conducted via a Sciex X500R Q-TOF mass spectrometer and Bruker autoflex maX MALDI-TOF/TOF under an inert atmosphere.

### X-Ray Single-Crystal Diffraction

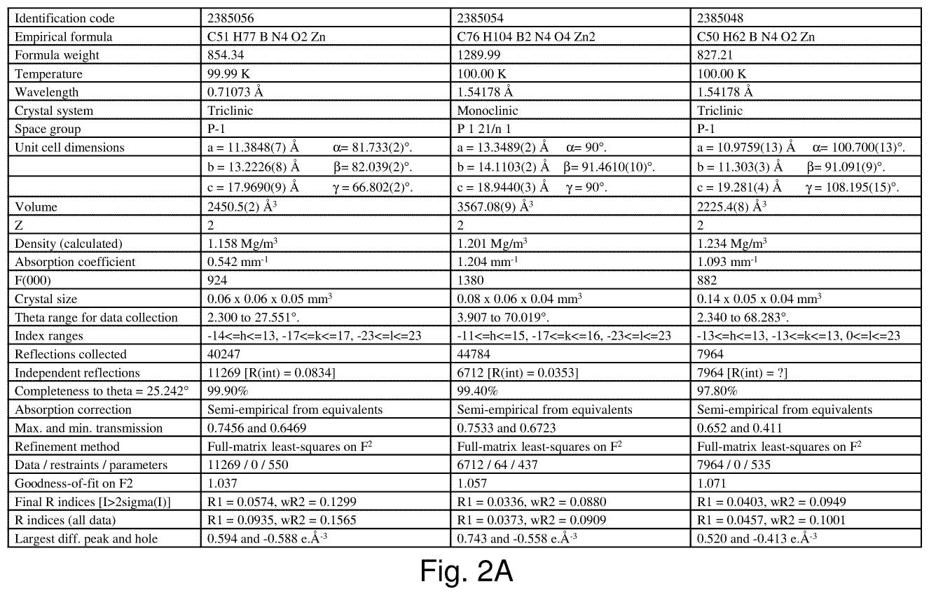

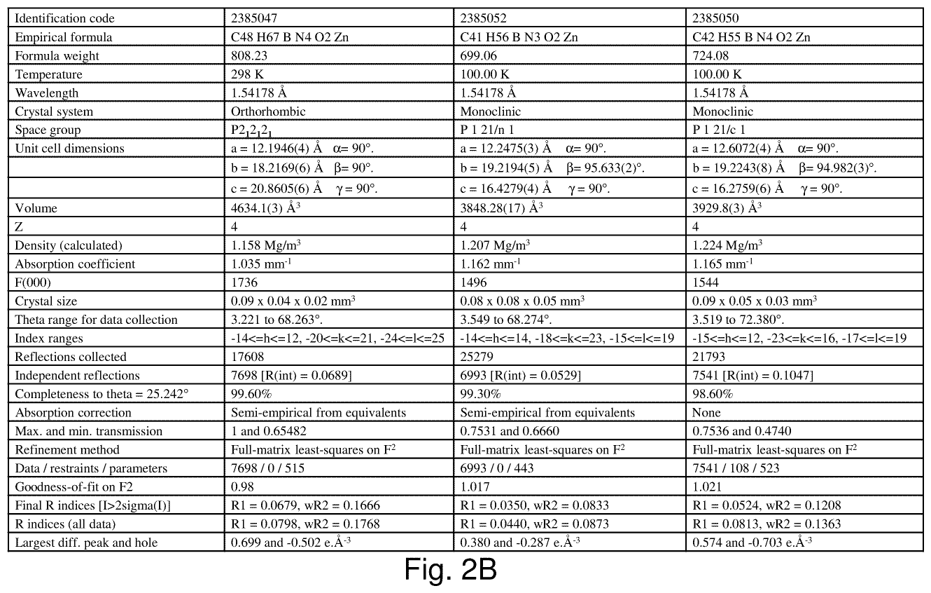

Single crystals of 6, 8, 10, 12 and 13 were mounted on a Hampton loop using polybutene and diffracted on a Bruker D8 Venture diffractometer with a PHOTON II CMOS detector at 100(2)K using Cu-Kα radiation (λ=1.54178 Å) or Mo-Kα radiation (λ=0.71073 Å). Single crystals of 11 were mounted on a Hampton loop using APIEZON N Grease and diffracted on a Rigaku XtaLAB Synergy-S diffractometer with a CCD detector at room temperature using Cu-Kα radiation (λ=1.54178 Å). Data was collected using multi-scan (φ and ω scans). All Bruker data were integrated by SANIT and scaled with either a numerical or multi-scan absorption correction using SADABS, and Rigaku data was integrated and scaled using CrysAlisPr Packages. Structures were solved by SHELXT and refined with SHELXL using the OLEX2 program. All non-hydrogen atoms were refined anisotropically, and all hydrogen atoms were added at idealized positions and refined using the riding model. X-ray crystallographic data have been deposited with the Cambridge Crystallographic Data Center: 2385047 (for 11), 2385048 (for 13), 2385050 (for 8), 2385052 (for 10), 2385054 (for 6), and 2385056 (for 12) (FIGS. 2A and 2B).

### Computational Details

For Natural Population Analysis (NPA) and orbital energy calculations, reported methodology for Mg-Bpin was employed for the purpose of meaningful comparison of the computational result. Within this methodology, using G09 Gaussian package⁹ at the BP86¹⁰ level of theory was used. SDD basis set with associated pseudopotential was used for Zn and Mg atoms, and 6-31G** was used for the rest of the atoms. Ultrafine grid was employed. NPA charge was calculated using NBO version 3¹⁴ with the better basis set 6-311++G**basis set for all atoms.

For the energy profiles presented, DFT calculations were carried out using G16 Gaussian package at the ωB97X-D level of theory. 6-311G* basis set was used for all atoms for optimization. The switch of the DFT methodology considers that the energy barriers obtained with the DFT methodology above are too low to be reasonable. Single point calculation was also carried out using 6-311+G* basis set for all atoms and solvation effect of toluene is added using SMD model. Vibrational frequency calculation was performed to verify all optimized intermediates as local minima and all optimized transition states as local maxima and to give relative free energies at 298 K. Intrinsic Reaction Coordinate (IRC) calculation was performed on optimized transition states to ensure that the transition states are on the same reaction pathway as the preceding and subsequent intermediates in the energy profile.

### Example 1

### Synthesis of Compound 6 (Formula II)

Compound 7 (Formula (IV)) (58.3 mg, 0.1 mmol) was dissolved in 2 mL of toluene in a 4 mL vial. One equivalent of bis(catecholato)diboron (B₂Cat₂, 23.7 mg, 0.1 mmol) was then added as a solid. The solution was stirred overnight, during which the color changed from pale yellow to chartreuse. The solvent was removed under vacuum, and the residue was extracted with hexane (2 mL, three times) and filtered through Celite. The pure product was isolated as single crystals from a frozen concentrated hexane solution (31.9 mg, 53%).

¹H NMR (400 MHz, C₆D₆) δ (ppm)=7.09 (m, 6H, Ar—H), 6.82 (dd, J=5.9, 3.3 Hz, 4H, cat-Ph), 6.55 (dd, J=5.9, 3.3 Hz, 4H, cat-Ph), 5.09 (s, 1H, NC(CH₃)CH), 3.34 (hept, 4H, CH(CH₃)₂), 1.73 (s, 6H, NC(CH₃)CH), 1.44 (d, J=6.8 Hz, 12H, CH(CH₃)₂), 1.20 (d, J=6.9 Hz, 12H, CH(CH₃)₂).

¹³C NMR (101 MHz, C₆D₆) δ (ppm)=167.64, 148.37, 144.70, 141.61, 126.15, 123.79, 121.77, 112.14, 96.24, 28.48, 24.63, 23.38, 23.35.

¹¹B NMR (96 MHz, C₆D₆) δ (ppm)=39.7

HRMS: simulated (M+H)⁺=601.2944, found=601.2972

### Example 2

### Synthesis of Compound 8

Compound 6 (20.0 mg, 0.033 mmol) was dissolved in toluene (2 mL), and DMAP (4.1 mg, 0.033 mmol) was added as a solid. The reaction was stirred for ten minutes, after which all solvent was removed under vacuum. The residue was then extracted with 1 mL of a 1:1 mixture of toluene and hexane and kept at −30° C. to yield products as single crystals (19.5 mg, 81%).

¹H NMR (400 MHz, C₆D₆) δ (ppm)=8.69 (d, J=5.9 Hz, 2H, DMAP), 7.15 (m, 6H, Ar—H), 6.98 (dd, J=5.8, 3.3 Hz, 4H, cat-Ph), 6.67 (dd, J=5.8, 3.3 Hz, 4H, cat-Ph), 5.91 (d, J=6.0 Hz, 2H, DMAP), 5.03 (s, 1H, NC(CH₃)CH) 3.55 (hept, 4H, CH(CH₃)₂) 2.10 (s, 6H, N(CH₃)₂, DMAP), 1.84 (s, 6H, NC(CH3)CH), 1.29 (d, J=6.9 Hz, 12H, CH(CH₃)₂), 1.23 (d, J=6.8 Hz, 12H, CH(CH₃)₂).

¹³C NMR (101 MHz, C₆D₆) δ (ppm)=166.88, 154.83, 148.94, 146.56, 142.36, 125.42, 123.73, 121.51, 112.00, 106.36, 94.73, 38.25, 28.65, 24.90, 24.19, 23.94.

¹¹B NMR (96 MHz, C₆D₆) δ (ppm)=42.16

HRMS: simulated (M+H)⁺=723.3790, found=723.3528

### Example 3

### Synthesis of Compound 10

### Route A

Compound 6 (30.0 mg, 0.05 mmol) was dissolved in 0.5 mL of toluene in a J-Young NMR tube, to which one equivalent of N,N′-dicyclohexylcarbodiimide (10.3 mg, 0.05 mmol) was added. The tube was then heated at 85° C. over 72 hours, during which the color of the solution turned from colorless to light green. The solution was extracted and dissolved in 2 mL of hexane, resulting in the precipitation of a small amount of white solid. The solution was then filtered and concentrated to 0.5 mL. Pure products were obtained as colorless single crystals by cooling the concentrated solution at −30° C. with a yield of 52% (36.3 mg).

¹H NMR (600 MHz, C₆D₆) δ (ppm)=7.16 (m, 6H, Ar-Nacnac), 6.97 (dd, J=5.7, 3.4 Hz, 2H, cat-Ph), 6.79 (dd, J=5.7, 3.4 Hz, 2H, cat-Ph), 4.90 (s, 1H, NC(CH₃)CH), 3.41 (hept, J=6.9 Hz, 4H, CH(CH₃)₂), 3.09 (tt, J=11.0, 4.0 Hz, 1H, CHN(Bcat)(CH₂)₂, 1.69 (s, 6H, NC(CH₃)CH), 1.53 (m, 2H, CH₂-Cy), 1.43 (m, 2H, CH₂-Cy), 1.37 (m, 2H, CH₂-Cy), 1.23 (d, J=6.9 Hz, 12H, CH(CH₃)₂), 1.19 (d, J=6.8 Hz, 12H, CH(CH₃)₂), 1.02 (m, 2H, CH₂-Cy), 0.58 (m, 2H, CH₂-Cy).

¹³C NMR (151 MHz, C₆D₆) δ (ppm)=169.13, 150.12, 143.47, 142.06, 126.04, 123.73, 120.76, 110.66, 95.66, 53.59, 40.00, 28.23, 25.72, 25.44, 24.19, 23.97, 23.41.

¹¹B NMR (193 MHz, C₆D₆)=26.74.

HRMS: simulated (M+Na)⁺=720.3656, found=720.3984

### Route B

Compound 11 (20 mg, 0.025 mmol) was dissolved in 0.5 mL of toluene in a J-Young NMR tube and then heated at 85° C. over 72 hours; no obvious color change was observed. All the solution was then removed under vacuum and extracted with hexane. Pure products were obtained by cooling the concentrated solution at −30° C. with a yield of 80% (14.0 mg).

### Example 4

### Synthesis of Compound 11

Compound 6 (30.0 mg, 0.05 mmol) was dissolved in 0.5 mL toluene in a J-Young NMR tube, to which one equivalent of N,N′-dicyclohexylcarbodiimide (10.3 mg, 0.05 mmol) was added. The tube was heated at 60° C. for 48 hours until total conversion of compound 6 was monitored. All the solvent was removed under vacuum, the residue was extracted with hexane and filtered to remove insoluble impurities. The pure product was isolated as single crystals by cooling the concentrated solution at −30° C. with a yield of 53% (21.4 mg).

¹H NMR (400 MHz, C₆D₆) δ (ppm)=7.50 (dd, J=7.9, 1.3 Hz, 1H, cat-Ph), 7.11 (m, 6H, Ar-Nacnac), 7.01 (m, 1H, cat-Ph), 6.94 (td, J=7.8, 1.3 Hz, 1H, cat-Ph), 6.81 (td, J=7.9, 1.3 Hz, 1H, cat-Ph), 5.02 (s, 1H, NC(CH₃)CH), 4.95 (ddt, J=12.0, 7.7, 3.9 Hz, 1H, C═NCH(CH₂)₂), 3.40 (hept, J=6.9 Hz, 2H, CH(CH₃)₂), 3.21 (hept, J=6.9 Hz, 2H, CH(CH₃)₂), 2.74 (C—NCH(CH₂)₂), 2.11 (m, 2H, CH₂-Cy), 1.93 (m, 2H, CH₂-Cy), 1.81, 1.80 (m, 2H, CH₂-Cy), 1.74 (m, 2H, CH₂-Cy), 1.64 (s, 6H, NC(CH₃)CH), 1.58 (m, 2H, CH₂-Cy), 1.41 (d, J=6.9 Hz, 6H, CH(CH₃)₂), 1.38 (m, 8H, CH₂-Cy), 1.21 (d, J=6.8 Hz, 6H, CH(CH₃)₂), 1.17 (m, 2H, CH₂-Cy), 1.06 (d, J=6.8 Hz, 6H, CH(CH₃)₂), 0.89 (d, J=6.8 Hz, 6H, CH(CH₃)₂).

¹³C NMR (101 MHz, C₆D₆) δ (ppm)=175.88, 168.18, 148.74, 146.54, 145.13, 142.91, 141.75, 125.94, 124.23, 123.84, 123.24, 122.35, 112.52, 112.28, 95.02, 69.15, 51.67, 35.95, 32.46, 29.10, 27.60, 27.04, 26.44, 24.95, 24.69, 24.53, 23.99, 23.77, 23.75.

¹¹B NMR (128 MHz, C₆D₆) δ (ppm)=27.96.

HRMS: simulated (M+H)⁺=807.4729, found=807.4793

### Example 5

### Synthesis of Compound 12

Compound 6 (30.0 mg, 0.05 mmol) was dissolved in 0.5 mL of toluene in a vial, to which one equivalent of ^{t}BuNC (8.3 mg, 11.5 μL 0.05 mmol) was added. A noticeable color change occurred from colorless to dark green and then to dark amber in 60 minutes. The solvent was then removed under vacuum. The residue was extracted with hexane and then filtered to remove insoluble impurities. The pure product was isolated as single crystals by cooling the concentrated solution at −30° C. with a yield of 68% (26.1 mg).

¹H NMR (600 MHz, C₆D₆) δ (ppm)=7.11 (m, 6H, Ar-Nacnac), 7.05 (dd, J=5.6, 3.3 Hz, 2H, cat-Ph), 6.77 (dd, J=5.7, 3.3 Hz, 1H, cat-Ph), 4.74 (s, 1H, NC(CH₃)CH), 3.56 (m, 2H, CH(CH₃)₂), 3.09 (m, 2H, CH(CH₃)₂), 1.59 (s, 6H, NC(CH₃)CH), 1.42 (s, 9H, tBu), 1.25 (m, 12H, CH(CH₃)₂), 1.16 (m, 12H, CH(CH₃)₂), 0.68 (s, 9H, tBu).

¹³C NMR (151 MHz, C₆D₆) δ(ppm)=168.96, 151.68, 143.58, 128.35, 126.50, 120.24, 110.68, 97.03, 58.49, 56.61, 30.77, 28.83, 23.58.

¹¹B NMR (96 MHz, C₆D₆) δ (ppm)=17.35.

HRMS: simulated (M+H)⁺=767.4416, found=767.4410

### Example 6

### Synthesis of Compound 13

Compound 6 (30.0 mg, 0.05 mmol) was dissolved in 0.5 mL of toluene in a J-Young NMR tube, to which one equivalent of azobenzene (9.2 mg, 0.05 mmol) was added. The tube was then heated at 60° C. for 12 hours, during which the deep orange solution gradually faded to light yellow. Afterward, the solvent was removed under vacuum. The residue was then extracted with a mixed solution of toluene/hexane/THF (2:4:1, 0.7 mL). The pure product was isolated as single crystals by cooling the extracted solution at −30° C., yielding 30.2 mg (77%).

¹H NMR (400 MHz, C₆D₆) δ (ppm)=7.40 (m, 2H, N-Ph), 7.02 (m, 5H, N-Ph), 6.94 (m, 6H, Ar-Nacnac), 6.79 (m, 5H, N-Ph (4H), cat-Ph (1H)), 6.45 (m, 3H, cat-Ph), 4.97 (s, 1H, NC(CH₃)CH), 3.28 (m, br, 4H, CH(CH₃)₂), 1.64 (s, 6H, NC(CH₃)CH), 1.11 (m, br, 24H, CH(CH₃)₂).

¹³C NMR (101 MHz, C₆D₆) δ (ppm)=170.24, 156.57, 148.82, 145.76, 144.06, 141.93, 129.16, 128.82, 126.63, 124.15, 122.28, 121.66, 117.79, 115.64, 112.27, 111.83, 96.04, 28.73, 24.36, 24.20, 24.02.

¹¹B NMR (128 MHz, C₆D₆) δ (ppm)=27.02.

HRMS: simulated (M+H)⁺=783.3790, found=783.5130

### Example 7

### Reversible Generation of Compound 6 from Compound 13

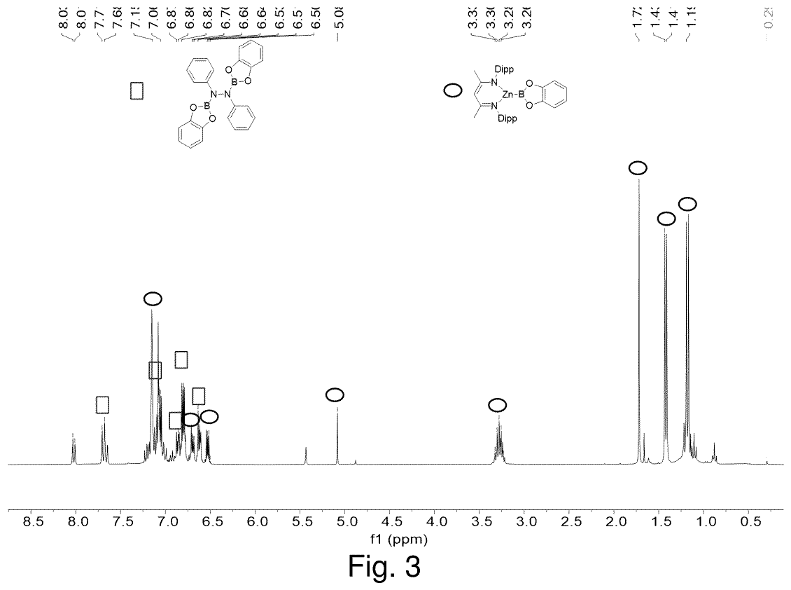

Compound 16 (19.6 mg, 0.025 mmol) was dissolved in 0.5 mL of C₆D₆ in a J-Young NMR tube, to which one equivalent of B₂cat₂ (6.0 mg, 0.025 mmol) was added. After 12 hours, the NMR spectrum showed regeneration of compound 6 and a set of signals of diborylated azobenzene products (FIG. 3).

### Example 8

### Catalytic Diborylation of Azobenzene Catalyzed by Compound 6

Azobenzene (182.2 mg, 1 mmol), B₂Cat₂ (237.8 mg, 1 mmol), and 5% of compound 6 (30 mg, 0.05 mmol) were dissolved in 10 mL of toluene in a sealed Schlenk tube. The solution was heated to 60° C. and stirred for 24 hours. Afterward, the solvent was removed, and the crude product was recrystallized from concentrated toluene (4 mL) at −30° C. The off-white crystalline product was washed with cold hexane (3×3 mL) and further dried under vacuum, yielding 281.4 mg (67%).

¹H NMR (300 MHz, C₆D₆) δ (ppm)=7.72 (m, 4H, N-Ph), 7.14 (m, 4H, N-Ph), 6.88 (t, J=7.4 Hz, 1H, N-Ph), 6.81 (dd, J=5.9, 3.4 Hz, 4H, cat-Ph), 6.66 (dd, J=5.9, 3.4 Hz, 4H, cat-Ph).

¹³C NMR (101 MHz, C₆D₆) δ (ppm)=148.73, 129.72, 123.58, 122.74, 117.60, 112.51.

¹¹B NMR (128 MHz, C₆D₆) δ (ppm)=27.18.

HRMS: simulated (M)⁺=420.1455, found=420.3459

### Example 9

### Characterization of Compound 6

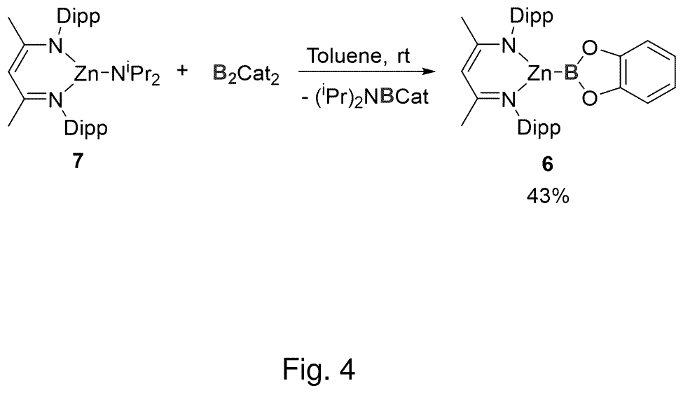

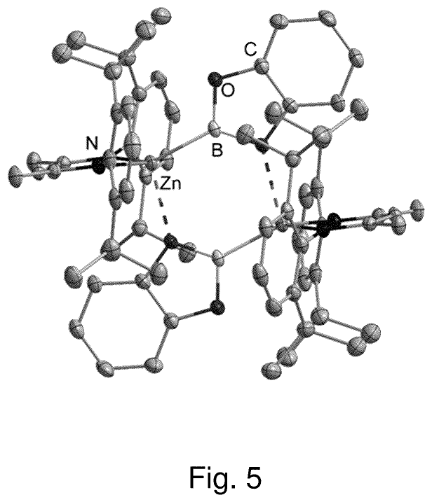

The zinc imide compound 7 was chosen as the starting material, as its reaction with B₂Cat₂ generates stable B—N bonded products, which might be a driving force for the formation of the Zn—B bond. Indeed, treatment of compound 7 and B₂Cat₂ at room temperature in toluene afforded the desired zinc boryl product 6 in a 53% isolated yield (FIG. 4). The ¹¹B NMR of 6 shows a broad singlet at 39 ppm, indicating the presence of a three-coordinated boron moiety. Furthermore, the formation of the Zn—B bond was unambiguously confirmed by single-crystal X-ray analyses (FIG. 5). Noteworthily, compound 6 exists as a dimer in the solid state, and the zinc atom is connected with an oxygen atom from the BCat group through a weak coordination interaction, forming a six-membered ring structure. Nevertheless, the ¹H NMR signal suggests that compound 6 adopts a monomeric state in solution. The Zn—B bond length of compound 6 (2.055(1) Å) is close to that of N-heterocyclic boryl zinc species (2.052, 2.075 Å).

### Example 10

### Reactivity of the Zn—B Bond in Compound 6

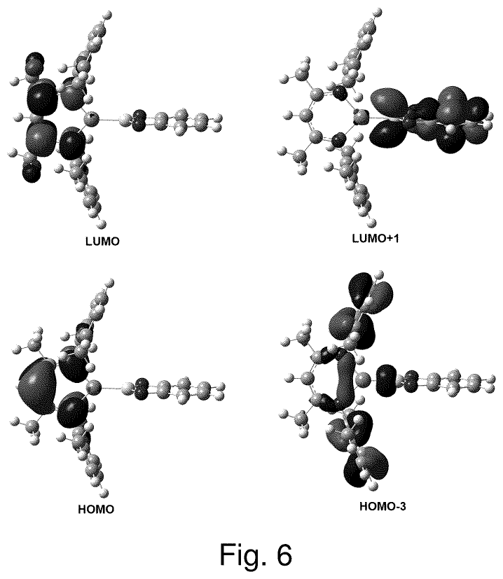

It is believed the metal boryl complexes serve as essential reactive intermediates or catalysts in the formation of various borylated reagents used in organic synthesis. It is also believed that the reactivity of the metal-boron bond is crucial for the further transformation. To gain deeper insights into the Zn—B bond in compound 6, DFT computation studies were carried out (FIG. 6) at the BP86 level of theory. The computed molecule is a simplified model of 6 by substituting Dipp groups with 2,6-dimethylphenyl moieties. The computed molecular orbitals indicate that both the HOMO and LUMO orbitals are predominantly comprised of the β-diketiminate ligand. Contributions from the Zn—B bond can be identified from the HOMO-3 and LUMO+1 orbitals. Furthermore, the Natural Bond Orbital (NBO) analysis revealed that the boron atom carries a charge of +0.478, which is higher than that of magnesium (+0.382) and lithium boryl species (+0.072). Meanwhile, the zinc metal center in compound 6 carries a charge of 0.950, indicating a more covalent character of the Zn—B bond compared with the known magnesium and lithium boryl species.

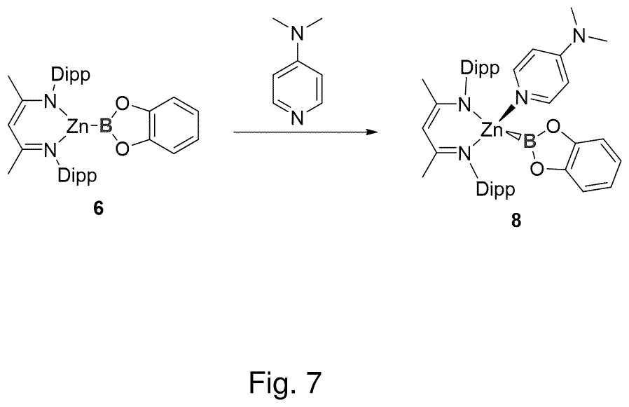

The reaction of compound 6 with 4-dimethylaminopyridine (DMAP) afforded a product, compound 8, where the DMAP unit was coordinated to the zinc atom, as confirmed by X-ray single-crystal analysis (FIG. 7). This observation implies that the zinc metal center in compound 6 is more electrophilic compared to the boryl group, which is consistent with the DFT computational results discussed above.

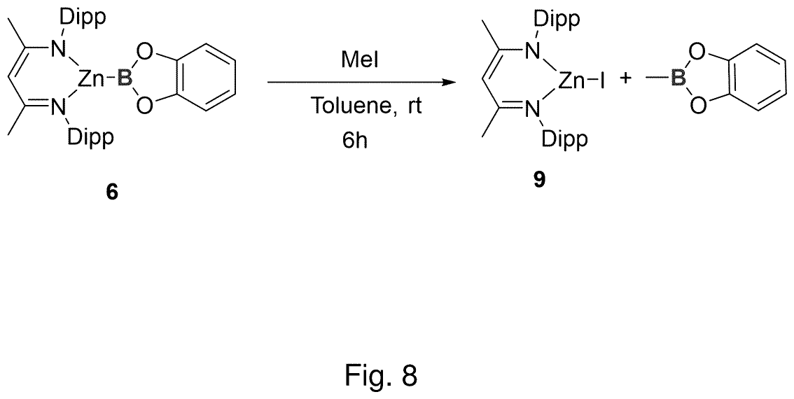

Both the magnesium and lithium boryl compounds have demonstrated their reactivity of nucleophilic boryl anions in reactions with electrophiles. Without wishing to be bound by theory, the similar reactivity of zinc-boryl compound 6 was also examined (FIG. 8). The reaction of compound 6 with Mel in C₆D₆ over 6 hours resulted in a clear conversion, as indicated by a new ¹¹B NMR signal at 35.2 ppm, suggesting the formation of the methyl-substituted boronic ester. Without wishing to be bound by theory, the synthetic route as described herein indicates a clear nucleophilic BCat⁻ derived from the Zn—B σ-bond, which is believed to be different from other reported MeBCat synthetic routes. Additionally, the zinc-I species 9 was identified by ¹H NMR. High-resolution mass spectrometry (HRMS) further confirmed the identities of the generated compounds. This reaction demonstrated the nucleophilic activity of the BCat⁻ anion derived from compound 6.

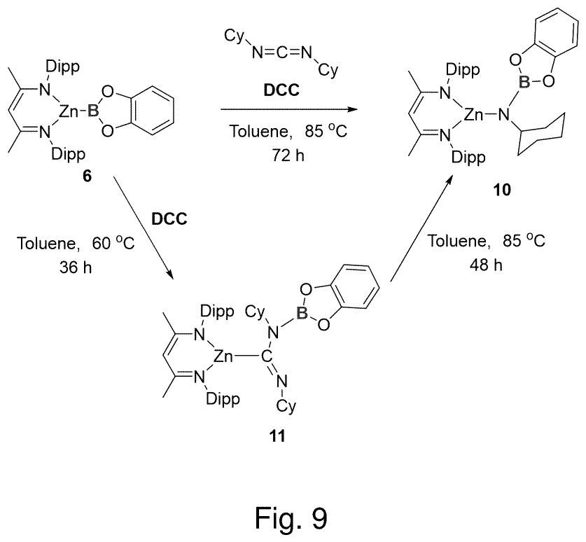

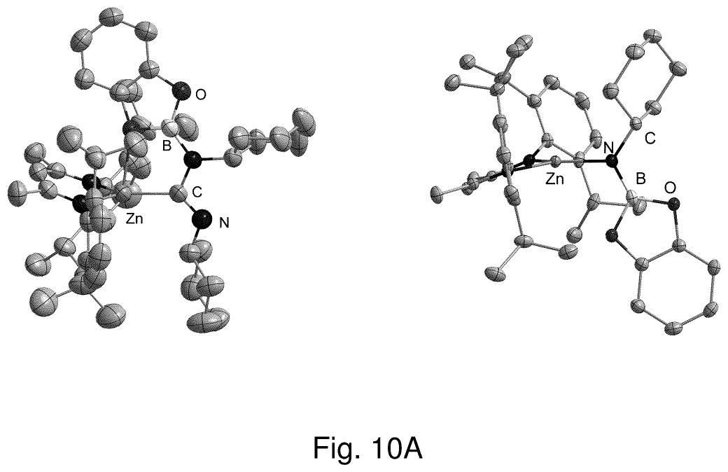

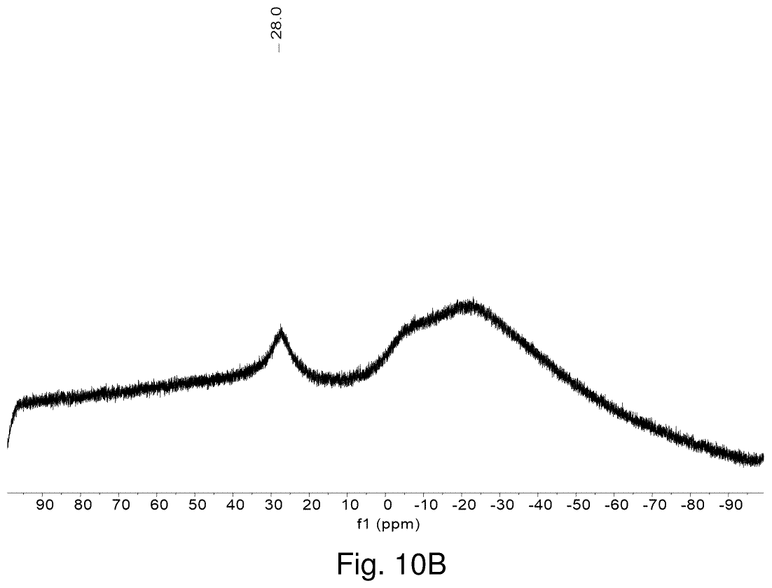

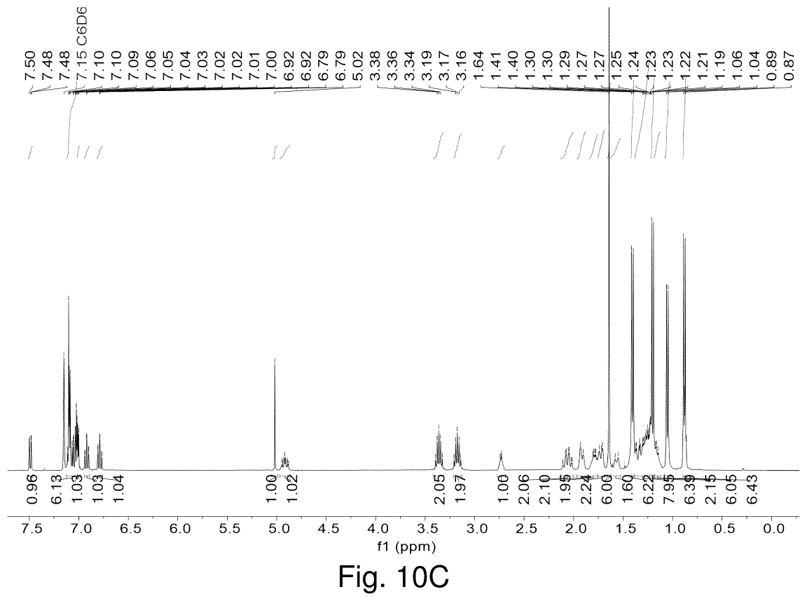

To explore further the reactivity of the Zn—B bond in compound 6, a series of reactions with unsaturated N-containing substrates was conducted. The reaction of compound 6 and N,N′-dicyclohexylcarbodiimide (DCC) has been explored. Without wishing to be bound by theory, the reaction of compound 6 and DCC unexpectedly gave a clean conversion to compound 10 at 85° C. (FIG. 9), instead of borylation that occurs at the C atom, which would result in a ZnN2C four-member ring. X-ray crystallographic analysis confirmed the structure of this compound 10 as a zinc imide complex. In this case, DCC acted as an equivalent of Cy-nitrene, which was inserted into the Zn—B bond (FIG. 10). This indicates a C═N bond cleavage event facilitated by the Zn-BCat compound 6 that displays unusual reactivity.

To elucidate the mechanism behind the unique bond cleavage process, a controlled experiment was conducted. Upon heating the reaction at 60° C., a new ¹¹B signal at 28.0 ppm was observed (FIG. 10B), and the ¹H NMR spectrum (FIG. 10C) also showed the appearance of a new set of signals, suggesting the presence of a stable transition intermediate. X-ray single crystal analysis confirmed the structure of this species, compound 11, as a 1,2-addition compound involving the Zn—B bond, where the zinc atom coordinates with the central carbon atom, and the BCat group is connected to the terminal N-Cy moiety. Continued heating of 11 at 85° C. led to a smooth transformation into the final product 10, proving it to be a key intermediate in this transformation. In these reactions, it is interesting to find out whether the related transformations have been initiated by a highly reactive nucleophilic or electrophilic boron moiety. To understand the reaction mechanism for the formation of compounds 10 and 11, DFT computational studies have been conducted, and the results will be discussed in the later part of the present disclosure.

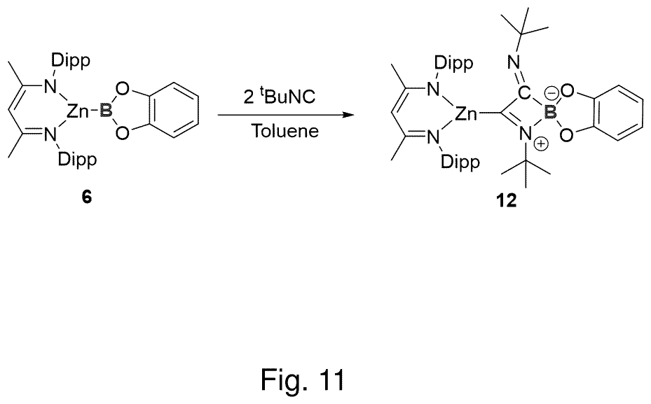

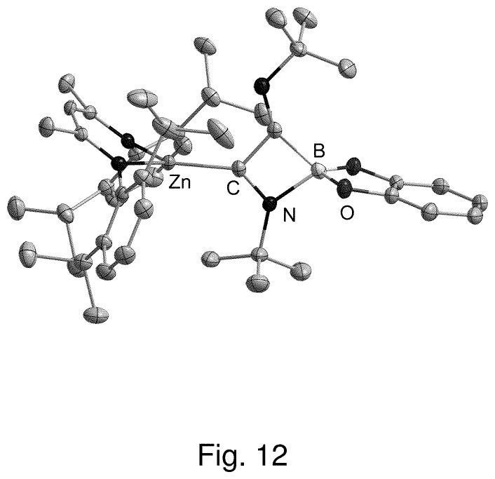

The reactivity of compound 6 towards isonitrile was also investigated. When an equimolar amount of ^{t}BuNC was added to a toluene solution of compound 6, an immediate color change from colorless to dark green was observed. ¹¹B NMR analysis revealed the formation of a new species with a signal at 17.2 ppm, along with the presence of unreacted compound 6. Upon the addition of another equivalent of ^{t}BuNC, a complete conversion of compound 6 was observed. The product, compound 12, was successfully isolated (FIG. 11). X-ray single crystal analysis revealed the formation of a C—C coupled moiety derived from ^{t}BuNC, coordinated with the BCat unit to generate a four-membered C₂NB heterocycle (FIG. 12). The C—N bond lengths of 1.280(4) and 1.301(4) Å, along with the terminal C—C bond length of 1.495(4) Å, suggest the formation of two N═C double bonds and a C—C single bond in the isonitrile-coupled moiety. This is in contrast to the reported Au—B(o-tol)₂ complex, where the isocyanide was transformed into an azaallenylgold compound, implying distinct reaction pathways in the two systems.

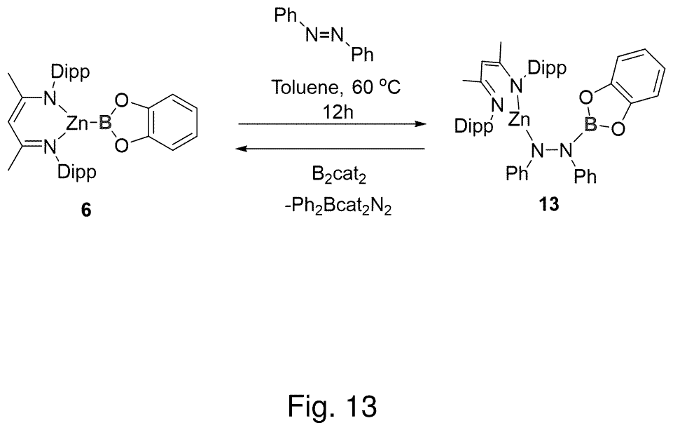

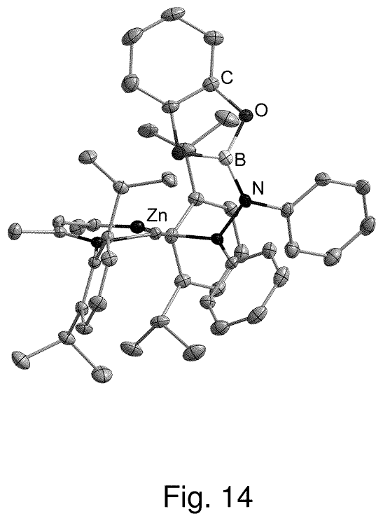

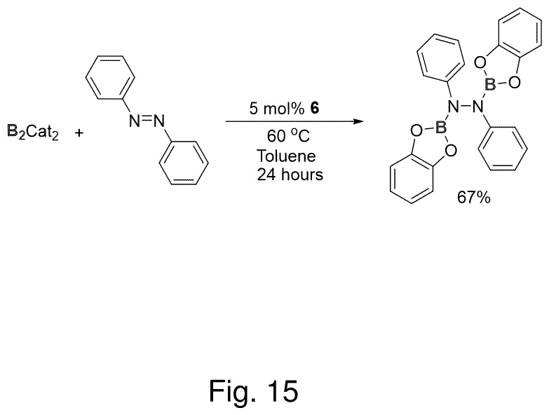

Additionally, compound 6 was found to react with azobenzene, forming a new zinc-imide product 13 (FIG. 13). The structure of compound 13 was confirmed by X-ray single-crystal analysis, which revealed the formation of Zn—N and B—N bonds (FIG. 14). The N—N bond length of 1.434(3) Å is within the general range of a N—N single bond. Typical diborylation of azobenzene requires either stoichiometric amounts of highly electrophilic boron reagents or noble metal catalysts. Without wishing to be bound by theory, it is believed that compound 6 might promote the catalytic diborylation of azobenzenes, driven by the regeneration of a strong B—N bond during the formation of compound 13. On this basis, the reaction of compound 13 with B₂Cat₂ was investigated. Unexpectedly, it is found that compound 6 was regenerated during the reaction, suggesting the establishment of a catalytic cycle. In light of this, compound 6 was utilized as a catalyst (5 mol %) for the diborylation of azobenzene with B₂Cat₂ in toluene at 60° C. This catalytic system successfully afforded the target diborylation product in an isolated yield of 67% (FIG. 15). The catalytic diborylation efficiency of azobenzene using the Zn-boryl complex of this work is comparable to that achieved with precious metal catalysts and without the addition of base in the catalytic system to make full use of the boron source.

### Example 11

### DFT Computational Studies

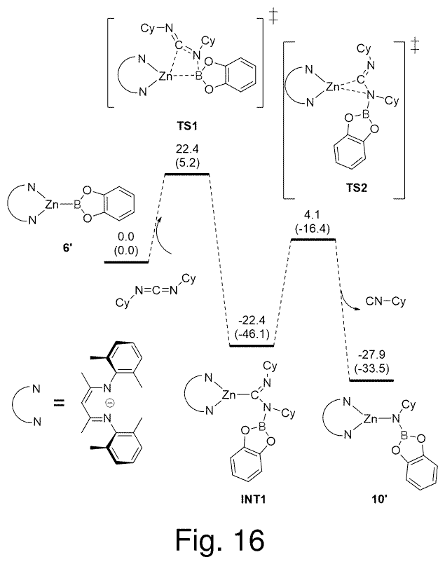

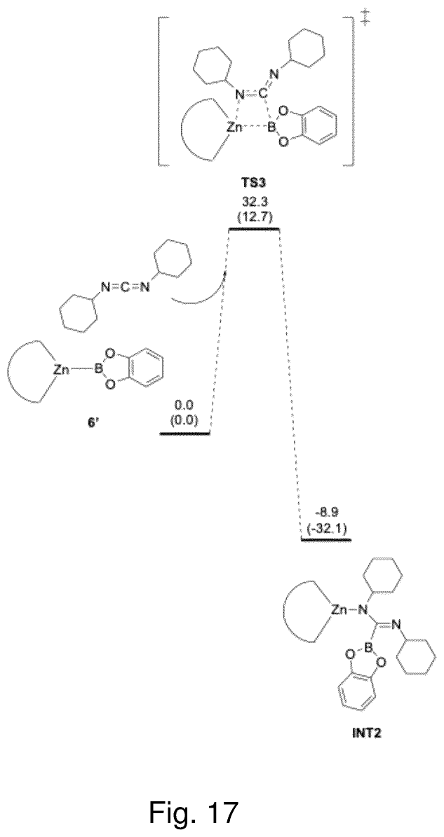

DFT computations were conducted on the reaction of compound 6 with DCC shown in FIG. 9 at ωB97X-D level in toluene to further study the reactivity of the Zn—B bond. This reaction was selected for DFT studies because the formation of 11 clearly signifies the potential electrophilic nature of the boryl ligand, allowing the distinction of a Zn—B bond and an Mg—/Li—B bond. The formation of the final thermodynamically more stable product 10 occurs through two steps (FIG. 16). In the first step, the Zn—B bond reacts with one of the C═N bonds in DCC to yield the zincate-borylation intermediate INT1 (a model for compound 11). This step proceeds through transition structure TS1 with an overall barrier of 22.4 kcal/mol. In the second step, the nitrogen atom bonded to the boryl group further coordinates with the Zn metal center, resulting in the cleavage of the Zn—C bond and the release of Cy-NC through the transition structure TS2. The second step requires overcoming a barrier of 26.5 kcal/mol, which is higher than that of the first step. This elucidates the experimental observation of 11 (INT1 in FIG. 16) as a product at a lower temperature. These findings contrast sharply with the reaction of Mg-BPin species with carbodiimide, where the boryl group attaches to the electrophilic carbon center in the final product. Consequently, the hypothetical reaction pathway in which the BCat acts as a nucleophile, attacking the electrophilic carbon atom of DCC was also examined. However, such a reaction mechanism needs to overcome a much higher energy barrier of 32.3 kcal/mol (FIG. 17). Based on these results, it can be concluded that a unique concerted reactivity of the Zn—B bond contributes to such an unexpected isonitrile elimination result observed in the reaction with DCC.

The invention has been given by way of example only, and various other modifications of and/or alterations to the described embodiment may be made by persons skilled in the art without departing from the scope of the invention as specified in the appended claims.

1. A zinc boryl complex comprising a formula of: 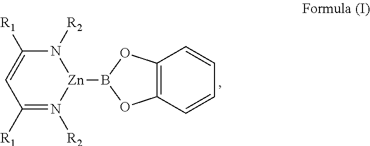
wherein R₁ is an alkyl having 1 to 6 carbon atoms; and R₂ is an aryl having 6 to 18 carbon atoms.

2. The zinc boryl complex as claimed in claim 1, wherein R₁ is selected from the group consisting of methyl, ethyl, isopropyl and tert-butyl.

3. The zinc boryl complex as claimed in claim 1, wherein R₂ is selected form the group consisting of mesityl (Mes), 2,6-diisopropylphenyl (Dipp), xylyl (Xyl), 2,6-diethylphenyl (Dep) and 2,4,6-triisopropylphenyl (Trip).

4. The zinc boryl complex as claimed in claim 1 comprises a formula of:

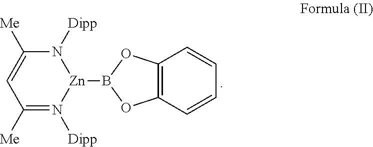

5. The zinc boryl complex as claimed in claim 4 adopts a monomeric state in solution.

6. The zinc boryl complex as claimed in claim 4 adopts as a dimer in solid state.

7. The zinc boryl complex as claimed in claim 4 is arranged to form an alkyl-substituted boronic ester by way of a nucleophilic reaction with a haloalkane under room temperature.

8. The zinc boryl complex as claimed in claim 4 is arranged to form a zincate-borylation intermediate by way of addition reaction of a C═N bond from carbodiimide.

9. The zinc boryl complex as claimed in claim 8, wherein the zincate-borylation intermediate is arranged to form an imide zinc complex by way of C═N bond cleavage.

10. The zinc boryl complex as claimed in claim 4 is arranged to form an isonitrile-coupled adduct, said adduct including a four-membraned C₂NB heterocycle.

11. The zinc boryl complex as claimed in claim 4 is arranged to form a zinc imide complex including a borylated N—N bond by way of reaction with azobenzene.

12. The zinc boryl complex as claimed in claim 4 is arranged to act as a catalyst in diborylation reaction with azobenzene.

13. A method for preparing zinc boryl complex as claimed in claim 1, comprising the step of contacting a zinc imide complex with bis(catecholato)diboron for metathesis reaction; wherein the zinc imide complex comprising a formula of: 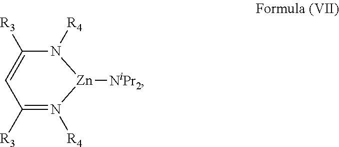
wherein R₃ is an alkyl having 1 to 6 carbon atoms; and R₄ is an aryl having 6 to 18 carbon atoms.

14. The method as claimed in claim 13, wherein R₃ is selected from the group consisting of methyl, ethyl, isopropyl and tert-butyl.

15. The method as claimed in claim 13, wherein R₄ is selected form the group consisting of mesityl (Mes), 2,6-diisopropylphenyl (Dipp), xylyl (Xyl), 2,6-diethylphenyl (Dep) and 2,4,6-triisopropylphenyl (Trip).

16. The method as claimed in claim 13, wherein the zinc imide complex comprises a formula of:

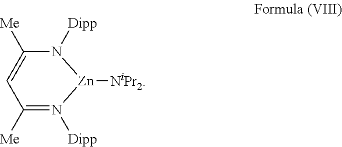

17. The method as claimed in claim 13, wherein the contacting comprises contacting the zinc imide complex and the bis(catecholato)diboron in a solvent.

18. The method as claimed in claim 17 comprising the steps of:
dissolving the bis(catecholato)diboron in a toluene solution of the zinc imide complex to form a reaction mixture for metathesis reaction; and
isolating the zinc boryl complex from the reaction mixture after the metathesis reaction.

19. The method as claimed in claim 18, wherein the zinc imide complex and the bis(catecholato)diboron have a molar ratio of about 1:1.

20. The method as claimed in claim 18, wherein the zinc boryl complex is isolated as single crystals.
